(19) United States
(12) Patent Application Publication
(10) Pub. No.: US 2017/0373360 A1
(43) Pub. Date: Dec. 28, 2017

(54) ARTICLES CONTAINING A HEAT SOURCE AND A HEAT SPREADER

(71) Applicant: EI DU PONT DE NEMOURS AND COMPANY, Wilmington, DE (US)

(72) Inventors: Stephen E. Burkhardt, Wilmington, DE (US); Owen C. Compton, Wilmington, DE (US); Thomas D. Lantzer, Wake Forest, NC (US); Jeffrey Scott Meth, Landenberg, PA (US); James Neal Singletary, Midlothian, VA (US)

(21) Appl. No.: 15/602,579

(22) Filed: May 23, 2017

Related U.S. Application Data
(60) Provisional application No. 62/354,947, filed on Jun. 27, 2016.

(51) Int. Cl. H01M 10/6554; H01M 10/6571; H01M 10/613; H01M 10/615; H01M 10/0525; F28F 21/06

(52) U.S. Cl. CPC H01M 10/6554; H01M 10/0525; F28F 21/065; H01M 10/613; H01M 10/615; H01M 10/6571

(57) ABSTRACT

This invention is related to articles containing a heat source and a heat spreader to conduct heat from the heat source. The heat spreader comprises a core of one or more drawn UHMWPE sheets. The sheets are planar, i.e., have dimensions in two directions that are considerably greater than that of the third dimension. No solvent is used during the drawing process. The draw ratio is typically 100 to 150. The density of a sheet is less than 0.90 g/cm³. A sheet has good thermal conductivity k_{∥} the direction of the draw. k_{∥} is at least 30 W/mK. The thermal conductivity perpendicular to the plane of the sheet k_{⊥} is greatly reduced. k_{⊥} is less than. 0.20 W/mK.

### FIELD OF THE INVENTION

This invention is directed to articles containing a heat source and a heat spreader to conduct the heat away from the heat source.

### BACKGROUND OF THE INVENTION

It is known that ultrahigh molecular weight polyethylene (UHMWPE) when ultradrawn can have high thermal conductivity and the related property, thermal diffusivity, in the direction of the draw. Chen et al., U.S. Pat. No. 9,109,846, disclose that this property may be exploited for conducting heat from electrically heated devices such as circuits, to improve their service and reliability by reducing their running temperature. They also disclose that their films are created by dissolving the polymer in a solvent, creating a gel, and stretching the gel to a high draw ratio, herein called ‘ultradrawing’, and then removing the solvent. Such gel-spun UHMWPE filaments have high thermal conductivity and Yamanaka et al., J. Appl. Polymer Science, Vol 101, p. 2619-2626 (2006) attribute the high thermal conductivity to the long, extended polymer chains. Correspondingly, drawn films or sheets of UHMWPE containing the long, extended chains have high conductivity in the direction of the draw.

It is further known that gel spun filaments have high crystallinity and densities typically within 95% of the theoretical density of polyethylene (1.00 g/cm³). For example, manufacturers of such fibers state that the density of such fibers is 0.97-0.98 g/cm³. This density is generally believed to be intrinsic to gel-spun fibers, and reflects the high crystallinity that occurs when the molecules are extended, aligned and collapsed into a coherent structure as the solvent is removed. Yamanaka et al. teach that the thermal conductivity of such elongated bodies of gel-spun, ultradrawn UHMWPE is proportional to their density, and therefore implicitly teach that high density is desired for high thermal conductivity.

Chen et al. also disclose that the value of gel-spun, elongated sheets of oriented UHMWPE as a thermally conducting material is the ratio of thermal conductivity in the drawn direction to thermal conductivity perpendicular to the drawn direction, i.e., perpendicular to the plane of the sheet. For commercial gel-spun UHMWPE, the thermal conductivity in the drawn direction, k_{∥}, is 20 W/mK and the thermal conductivity transverse to the drawn direction, i.e., perpendicular to the plane of the sheet, k_{⊥}, is 0.2 W/mK and the ratio k_{∥}/k_{⊥}=100. To increase this ratio, the gel state polymer should be drawn more. However, this is commercially prohibitive. Extending the polymer more and more to increase the ratio of thermal conductivities increases the expense and complexity of the equipment needed to draw the polymer, adding significant cost.

Therefore, a different approach is needed to increase the ratio of the thermal conductivities of oriented UHMWPE.

### SUMMARY OF THE INVENTION

This invention provides an article comprising,
a) a heat source; and
b) a heat spreader in direct contact with the heat source, the heat spreader comprising a core of one or more UHMWPE sheets drawn in the absence of a solvent, each UHMWPE sheet having a density ρ less than 0.90 g/cm³, a thermal conductivity in the drawn direction, k_{∥}, of at least 30 W/mK, a thermal conductivity perpendicular to the plane of the sheet, k_{⊥}, of less than 0.20 W/mK and a ratio of k_{∥}/k_{⊥} greater than 200.

In an embodiment the density ρ is less than 0.85 g/cm³.

In another embodiment k_{⊥} is less than 0.15 W/mK.

In still another embodiment k_{∥} is at least 40 W/mK.

In an embodiment the ratio of k_{∥}/k_{⊥} is greater than 250.

In one class of embodiments, the heat source is a battery and the heat spreader conducts heat away from the battery to maintain an operable battery temperature.

In another class of embodiments, the heat source is a polymeric resistive film or circuit and the heat spreader conducts heat away from the heat source to a battery to heat the battery to optimal battery operating temperature.

### DETAILED DESCRIPTION OF INVENTION

This invention is related to articles containing a heat source and a heat spreader to conduct heat away from the heat source. In one embodiment the heat spreader conducts heat from the heat source in order to cool the heat source, e.g., a battery. In another embodiment the heat spreader conducts heat from the heat source in order to heat another component of the article, e.g., to heat a battery. In still another embodiment the article contains multiple heat generating sources and a heat spreader conducts heat between them.

The heat spreader comprises a core of one or more drawn UHMWPE sheets. The sheets are planar, i.e., have dimensions in two directions that are considerably greater than that of the third dimension. The sheets are prepared following the teachings of Harding et al., U.S. Pat. No. 7,858,004. No solvent is used during the drawing process. The draw ratio is typically 100 to 150. During the drawing process, the chains of polymer within a sheet are oriented, i.e., substantially aligned, in the direction of the draw. The sheet is cavitated during drawing. The density of a sheet is less than 0.90 g/cm³ and in some embodiments less than 0.85 g/cm³. The densities are determined using the sheet areal density and the thickness of the sheet as well as by helium pycnometry.

A sheet has good thermal conductivity k_{∥} in the direction of the draw. k_{∥} is at least 30 W/mK. In another embodiment k_{∥} is at least 35 W/mK. In still another embodiment k_{∥} is at least 40 W/mK. The thermal conductivity perpendicular to the plane of the sheet k_{⊥} is greatly reduced. k_{⊥} is less than. 0.20 W/mK. In another embodiment k_{⊥} is less than 0.18 W/mK. In still another embodiment k_{⊥} is less than 0.15 W/mK. The thermal conductivity in the direction in the plane of the sheet perpendicular to the drawn direction is also relatively low compared to k_{∥}.

The ratio of k_{∥}/k_{|} is greater than 200. In another embodiment the ratio of k_{∥}/k_{⊥} is greater than 250. In still another embodiment the ratio of k_{∥}/k_{⊥} is greater than 400. The alignment of the chains of polymer results in the good thermal conductivity in the direction of the draw. It is believed that during the stretching of the drawing process voids are introduced into the sheet which result in the decrease in density noted above and also result in much lower thermal conductivities in the two orthogonal directions to the direction of the draw.

In one embodiment the core of the heat spreader is comprised of two or more UHMWPE sheets. This provides increased heat dissipation as well as increased mechanical strength. The two or more sheets may be arranged in a layer structure with the drawn direction of each sheet aligned with the drawn direction of every other sheet in the core. Alternatively, the sheets may be divided into two sets with the sheets arranged alternately in a layer structure with the drawn direction of one set at an angle with respect to the drawn direction of the second set to provide thermal conduction in two directions. In one embodiment the angle is 90 degrees. In one embodiment the sheets in a layer structure may be bonded together, e.g., by using an adhesive

In an embodiment an adhesive with a thermal conductivity of at least 0.2 W/mK is coated on one or both sides of the UHMWPE core. The adhesive may be adhered to the heat source to minimize thermal contact resistance to the heat source. In one embodiment, the adhesive is an acrylic adhesive with a thermal conductivity of at least 0.5 W/mk.

In an embodiment the heat source is a battery. In one such embodiment the battery contains a series of cells and the heat spreader is in thermal contact with the cells. A lithium battery is one embodiment of such a battery. Individual cell cooling in lithium ion battery packs is important for both safety and performance. As cell temperature increases, so does the possibility of irreversible decompositions that can lead to “thermal runaway”, a state in which the battery self-heats and ultimately catastrophically fails. During the course of this catastrophic failure, there can be a failure of cell containers, and plasmas and electrically conductive gases may be present that create short circuit conditions within the pack, further exacerbating the rapid and energetic failure of the pack. Additionally, high cell temperatures typically lead to premature cell failure through either active lithium loss due to side reactions, or impedance growth. While undergoing thermal runaway, temperatures in the cell can reach many hundreds of degrees. These extreme temperatures and the resulting pressures lead to cell rupture, fire and the decomposition of cell materials into potentially hazardous compounds such as hydrofluoric acid and toxic phosphate derivatives. Cell impedance itself leads to greater heat generation within the cell and therefore self-propagates. Impedance also creates an issue when individual cells in a circuit are not impedance matched. This leads to a situation where the voltage across one cell is dissipated to a greater extent than neighboring cells and under charge or discharge conditions the cells no longer symmetrically deliver or receive charge. For all of these reasons, lithium ion cells in a pack are kept as cool as possible while balancing against economic and performance targets. Cooling systems may take multiple forms including passive air, active air, refrigeration (direct expansion) and liquid cooling. Cells are placed in contact with a heat sink, cooling plate or heat spreader that evenly distributes and moves heat away from the cell. Many of the current solutions using these cooling fins or heat spreaders are also electrically conductive. Specific examples from the literature include Cu, Al or graphite. In these cases, the potential for short circuiting within the pack is increased, even if the cells are electrically isolated from the cells. For example, a small metal shaving may rupture a pouch cell under the compression conditions of the cell stack. The cell then becomes short circuited to the cooling system, resulting in any number of electrical problems. On the other hand, an electrically insulating heat spreader, such as a high thermal conductivity UHMWPE polymer, is beneficial in this system for both electrical isolation as well as heat spreading, cooling and overall thermal management. In this case, an added layer of protection may be applied with cooling fins or heat sinks, or the cooling element may be composed entirely of the polymer material. Additionally, the anisotropic thermal conductivity of the heat spreader of the invention allows adjacent cells to be thermally protected from one another so that a cell that has gone to higher impedance and shown higher heat generation will be less likely to influence the temperature of other cells in the battery pack.

In another class of embodiments involving battery back heating, the heat source is a polymeric resistive film or circuit and the heat spreader conducts heat from the heat source to a battery to heat the battery to an optimal battery temperature. In cold climates, a battery pack, particularly a Li-ion pack, may need to be heated to reach an optimal operating temperature. Current solutions to pack heating typically involve circulating a heated liquid through the coolant channels of the battery pack. However, circulating a heated liquid is inefficient due to high thermal mass of the combined liquid and circulation infrastructure, as well as pumping losses incurred by moving the liquid. A more efficient approach involves combining a heating element with the anisotropic thermally conductive heat spreader of the invention. The heating element may be a resistive heat generating film or circuit. The resistive film may be a polymeric resistive film, e.g., a DuPont™ Kapton® polyimide film. It may also be a film comprised of a positive temperature coefficient material. Uniform heating of the cell, module or pack can be accomplished directly by the heat spreader or by a combination of the heat spreader and cell fins in thermal contact with the heat spreader. An advantageous property would be flexibility, such that high reliability under mechanical agitation, and simplified manufacturing can be achieved.

In another embodiment the heat source is an antenna. Embodiments include a wireless device, e.g. a cellular phone.

In still another embodiment, the article is a display panel.

### EXAMPLES

### Example 1

A sheet of ultrahigh molecular weight polyethylene (UHWPE) was prepared following the teachings of Harding et al., U.S. Pat. No. 7,858,004, with a total draw ratio of about 130. The UHMWPE powder used was Ticona GUR X168 (Celanese, Florence, Ky. U.S.A.). The resulting sheet areal density was about 48-g/m². Using the sheet areal density and measurements of the sheet thickness by digital micrometer, the density of the sheet was calculated to be 0.80±0.03 g/cm³. Average heat of fusion per differential scanning calorimeter, measured in an isothermal ramp of 10° C./min, was 229 J/g, with an average melt temperature of 148° C.

### Example 2

A sheet of ultrahigh molecular weight polyethylene (UHWPE) was prepared following the teachings of Harding et al., U.S. Pat. No. 7,858,004, with a total draw ratio of about 130. The UHMWPE powder used was 540RU (Mitsui Chemicals America, U.S.A.). The resulting sheet areal density was about 49-g/m². Using the sheet areal density and measurements of the sheet thickness by digital micrometer, the density of the sheet was calculated to be 0.80±0.03 g/cm³. Using helium pycnometry, the density was measured as 0.83 g/cm³. Average heat of fusion per differential scanning calorimeter, measured in an isothermal ramp of 10° C./min, was 255 J/g, with an average melt temperature of 150° C.

### Example 3

The thermal conductivity perpendicular to the plane of the sheet, k_{⊥}, was determined for the sheets of UHMEPE made in Examples 1 and 2. Sheets of UHMWPE from Examples 1 and 2 were cut into squares and laid atop of one another other with the edges aligned and with the orientation directions rotated at right angles relative to adjacent layers, so the stack would subsequently be able to withstand pressure without fracturing parallel to the orientation direction. A thin (6-gsm nominal basis weight) film of linear low density polyethylene was interleaved between each layer and on the surfaces to mitigate potential effects of surface resistance. The interleaved material had a melt temperature of around 97.6° C. as measured by differential scanning calorimeter, using a 10° C./minute ramp rate. A stack of 180 layers of UHMWHE sheet from Examples 1 and 2 were used in separate experiments. The stack was conditioned to temperature equilibrium in a laboratory at 20° C. nominal temperature. A thermocouple was placed in the midplane of the stack between layers, approximately 2-cm in from the midpoint of one edge. The stack was then placed between massive, substantially parallel, steel platens, preheated to 101° C. by electrical resistance heaters, inside a vacuum chamber. The chamber was evacuated to 98.1-kPa gage vacuum and held at this reduced pressure for five minutes. Thereafter, the platens were closed with a pressure of 13.6-Bar. Temperature in the midplane of the stack was measured from the thermocouple every minute for 18 minutes, at which point the temperature had essentially plateaued to equal the platen temperature within the resolution of the transducers.

The heat transfer of the experiment was modeled as a one dimensional conduction through a continuum between isothermal boundary conditions. The steel platens were modeled as isothermal given their large thermal mass compared to the small samples, and the fact that they were electrically heated. The heat flow was modeled as one dimensional conduction because convection and edge loss were mitigated by evacuation and radiation was mitigated by the expected low transmissivity of the polished surfaces of the steel platens. The material was reasonably modeled as a continuum because the interleaves melted and wetted the sheet surfaces and were pressed together under high pressure to mitigate surface contact resistance. The resulting equation used, following the teachings of Prifti et al., “Hardened Tuned-Wall Plastic Radomes for Military Radars”, U.S. Army Materials and Mechanics Research Center, Watertown, Mass. 1976, is

$$( T - {T}_{0} ) / ( {T}_{1} - {T}_{0} ) - \frac{2}{\text{?}} {\sum }_{\text{?} = 1}^{\text{?}} [ 1 - \frac{{( - 1 )}^{\text{?}}}{\text{?}} ] \text{?} [ \frac{- {a}_{⊥} \text{?}}{{X}^{2}} ] \text{?} ( \frac{\text{?}}{X} )$$

$$\text{?} \text{indicates text missing or illegible when filed}$$

where

T=temperature at time t and location x

T₀=platen temperature (101° C.)

T₁=initial temperature (20° C.)

α_{⊥}=thermal diffusivity through the thickness

X=sample thickness

The first n=6 terms of the sine series expansion were used. The data starting at six minutes from platen closure was used to fit the equation. By iteratively assuming various values for α_{⊥}, a best fit was determined to be α_{⊥}=6×10⁻⁸ m²/s.

Thermal conductivity through the thickness, k_{⊥}, is known to be related to thermal diffusivity α_{⊥} by

k_{⊥}=α_{⊥}ρCₚ

where ρ is the density and Cₚ is the specific heat capacity. The supplier of the UHMWPE powder listed the specific heat capacity of UHMWPE as up to 1840 J/kg-° K. Using this value for specific heat capacity and the highest density determined for the sheets (via helium pycnometry), thermal conductivity through the thickness of the sheets of Examples 1 and 2 were determined to both be k_{⊥}=0.09 W/(m-° K).

### Example 4

The thermal conductivity k_{∥} of the sheets of Examples 1 and 2 in the direction of the draw, the orientation direction, were measured by the Angstrom method (Conduction of Heat in Solids, H. S. Carslaw, J. C. Jaeger, Second Edition, Clarendon Press, Oxford, 1959, Page 136). The results were k_{∥}=45.4 W/(mK) for Example 1 and k_{∥}=51.0 W/(mK) for Example 2.

The results obtained in Examples 3 and 4 are compared with results for commercial gel-spun UHMWPE fiber (Dyneema® Fact Sheet)

| | UHMWPE | k_{∥} | k [symbol] | |
|---|---|---|---|---|
| Item | Process | W/(mK) | W/(mK) | k_{∥}/k_{⊥} |
| Commercial | solution spinning | 20 | 0.2 | 100 |
| Comparative | process | | | |
| Example 1 | absence of solvent | 45.4 | 0.09 | 504 |
| Example 2 | absence of solvent | 50.1 | 0.09 | 557 |

[symbol]

indicates data missing or illegible when filed

### Example 5

A sheet of ultrahigh molecular weight polyethylene (UHMWPE) was prepared following the teachings of Harding et al., U.S. Pat. No. 7,858,004 to a total draw ratio of about 130. The UHMWPE was 540RU powder, from Mitsui Chemicals America, U.S.A. The resulting sheet areal density was about 49-g/m². From the sheet areal density and measurements of the sheet thickness by digital micrometer, the density of the sheet was 0.80±0.03 g/cm³. From helium pycnometry, the density was 0.83 g/cm³. Nominal tape linear density was 108,000 denier.

A sample was prepared from this sheet by cutting out an approximately 1 cm×3 cm strip. Additional samples were prepared by cutting out discs with diameter=33 mm.

The 1 cm×3 cm strip sample was tested for thermal conductivity using the Angstrom method to determine k_{∥}. The k_{∥} was found to be 49.16 W/mK

The 33 mm discs were used to determine the through-plane thermal conductivity following the ASTM D5470-06 specification, Standard Test Method for Thermal Transmission Properties of Thermally Conductive Electrical Insulation Materials. The test was performed on stacks of discs containing 1, 2 and 3 discs at a pressure of 700 kPa. A best fit regression was applied to separate the interfacial effects from the through-plane thermal conductivity, k_{⊥}. The k_{⊥} was 0.17 W/mK.

The results of these tests are summarized below:

| Thermal Conductivity k_{∥} | 49.16 W/mK |
|---|---|
| Thermal Conductivity k_{⊥} | 0.17 W/mK |
| Anisotropy Ratio | 289 |

What is claimed is:

1. An article comprising,
a) a heat source; and
b) a heat spreader in direct contact with the heat source, the heat spreader comprising a core of one or more UHMWPE sheets drawn in the absence of a solvent, each UHMWPE sheet having a density ρ less than 0.90 g/cm³, a thermal conductivity in the drawn direction, k_{∥}, of at least 30 W/mK, a thermal conductivity perpendicular to the plane of the sheet, k_{⊥}, of less than 0.20 W/mK and a ratio of k_{∥}/k_{⊥} greater than 200.

2. The article of claim 1, wherein the density ρ is less than 0.85 g/cm³.

3. The article of claim 1, wherein k_{⊥} is less than 0.15 W/mK.

4. The article of claim 1, wherein k_{∥} is at least 40 W/mK.

5. The article of claim 1, wherein the ratio of k_{∥}/k_{⊥} is greater than 250.

6. The article of claim 1, wherein the density ρ is less than 0.85 g/cm³, k_{⊥} is less than 0.15 W/mK, k_{∥} is at least 40 W/mK and the ratio of k_{∥}/k_{⊥} is greater than 250.

7. The article of claim 1, wherein the core of the heat spreader is comprised of two or more sheets and the two or more sheets are arranged in a layer structure with the drawn direction of each sheet aligned with the drawn direction of every other sheet in the core.

8. The article of claim 1, wherein the core of the heat spreader is comprised of two or more sheets and the two or more sheets are divided into two sets with the sheets arranged alternately in a layer structure with the drawn direction of one set perpendicular to the drawn direction of the second set to provide thermal conduction in two directions.

9. The article of claim 1, wherein an adhesive with a thermal conductivity of at least 0.2 W/mk is coated on one or both sides of the UHMWPE core and is adhered to the heat source.

10. The article of claim 9, wherein the adhesive is an acrylic adhesive with a thermal conductivity of at least 0.5 W/mk.

11. The article of claim 1, wherein the heat source is a battery and the heat spreader conducts heat away from the battery to maintain an operable battery temperature.

12. The article of claim 11, wherein the battery contains a series of cells and the heat spreader is in thermal contact with the cells.

13. The article of claim 12, wherein the battery is a lithium battery.

14. The article of claim 1, wherein the article is an antenna.

15. The article of claim 1, wherein the article is a display panel.

16. The article of claim 1, wherein the heat source is a resistive heat generating film or circuit.

17. The article of claim 16, wherein the heat spreader conducts heat from the heat source to a battery to heat the battery to optimal battery operating temperature.

18. The article of claim 1, wherein the article contains multiple heat sources and a heat spreader conducts heat between them.
